(19) United States
(12) Patent Application Publication
(10) Pub. No.: US 2015/0206231 A1
(43) Pub. Date: Jul. 23, 2015

(54) METHOD AND APPARATUS FOR ONLINE AUCTIONING

(71) Applicant: DIMEX PTY LTD, Sydney (AU)

(72) Inventors: Joel Cameron Smith, Sydney (AU); Carlo Cossalter, Sydney (AU)

(73) Assignee: DIIMEX PTY LTD, Sydney (AU)

(21) Appl. No.: 14/420,361

(22) PCT Filed: Aug. 8, 2013
(86) PCT No.: PCT/AU2013/000877

§ 371 Date: Feb. 7, 2015

(30) Foreign Application Priority Data
Aug. 8, 2012 (AU) 2012903398

(51) Int. Cl. G06Q 30/08

(52) U.S. Cl. CPC G06Q 30/08

(57) ABSTRACT

The invention provides apparatus for enabling an online auction comprising a processor, a database module coupleable to the processor, the database module adapted to retain data representing auction items, and a server coupleable to the processor, the server adapted to present an auction interface to a consumer on a display. The auction interface is adapted to present a representation of a set of two or more auction items within a group auction panel, present representations of at least one member of the set of auction items within an individual auction panel, and receive bids from respective consumers on the set of auction items and/or individual auction items within the set of auction items. The invention further provides related methods and interfaces.

### FIELD OF THE INVENTION

The present invention relates to auctioning and in particular to online auctioning.

The invention has been developed primarily for use as an apparatus and method of an integrated online auction format that incorporates simultaneous auction for each of a plurality of items and a corresponding collection of items, which will be described hereinafter with reference to this application. However, it will be appreciated that the invention is not limited to this particular field of use.

### BACKGROUND OF THE INVENTION

Any discussion of the prior art throughout the specification should in no way be considered as an admission that such prior art is widely known or forms part of the common general knowledge in the field.

Known methods and apparatus for providing auction service incorporate various features of traditional and online auctions. For example, an integrated auction can include a live, in-person auction component and an online bidding environment component. Bidding information associated with an item in the online bidding environment is updated to reflect a current bid associated with the item in the live, in-person auction. In this environment, a bidder submits a bid in regard to single items presented by the seller.

Freelance professionals such as photographers, camera operators and journalists typically wish to present auction items to target markets such as media companies, advertising agencies and corporates. In many cases these freelance professionals operate in hazardous environments in which data networks are often unreliable. For example, where a freelance professional generates content relating to a natural disaster, act of warfare or other significant event, the event itself may cause data network services to become unavailable.

There is a need in the art for alternative auction methods and apparatus, that can enable a seller to present goods or services for auction in both a plurality of discrete items (or discrete item sets) and as a collection for those discrete items (or discrete item sets).

In some environments a freelance professional may be prevented from presenting goods or services for auction as both a plurality of discrete items and as a collection due to data network constraints.

It is an object of preferred embodiments of the present invention to address some of the aforementioned disadvantages. An additional or alternative object is to at least provide the public with a useful choice.

### SUMMARY OF THE INVENTION

According to an aspect of the invention there is provided apparatus for enabling an online auction comprising a processor; a database module coupleable to the processor, the database module adapted to retain data representing auction items; and a server coupleable to the processor, the server adapted to present an auction interface to a consumer on a display, the auction interface adapted to: present a representation of a set of two or more auction items within a group auction panel; present representations of at least one member of the set of auction items within an individual auction panel; and receive bids from respective consumers on the set of auction items and/or individual auction items within the set of auction items.

The term “comprising” as used in this specification and claims means “consisting at least in part of”. When interpreting statements in this specification and claims which include the term “comprising”, other features besides the features prefaced by this term in each statement can also be present. Related terms such as “comprise” and “comprised” are to be interpreted in similar manner.

Preferably the apparatus is adapted to determine a minimum bid for the set of auction items at least partly from the aggregate of leading bids on the individual auction items within the set of auction items.

Preferably the minimum bid for the set of auction items exceeds the aggregate of leading bids on the individual auction items within the set of auction items by a predetermined amount.

Preferably the auction interface is further adapted to present on the display a comparison between the leading bid on the set of auction items and the aggregate of leading bids on the individual auction items within the set of auction items.

Preferably the auction interface is further adapted to receive a maximum bid from at least one of the consumers on the set of auction items.

Preferably the auction interface is further adapted to present the group auction panel above the individual auction panel on the display.

Preferably the apparatus is adapted to determine a duration for the online auction as the lesser of a predetermined maximum duration and the expiry of a predetermined break period during which there are no bids placed.

According to an aspect of the invention there is provided apparatus for enabling receiving auction data from at least one contributor for an online auction, the apparatus comprising a processor; a database module coupleable to the processor, the database module adapted to retain data representing auction items; and a server coupleable to the processor, the server adapted to present a contributor interface to a contributor on a display, the contributor interface adapted to receive two or more auction items from the at least one contributor, the auction items relating to a single event or similar events assigning at least two of the auction items to a set of auction items; and receive bids from respective consumers on the set of auction items and/or individual auction items within the set of auction items.

Preferably the contributor interface is further adapted to receive at least one auction item from two or more contributors relating to a single event or similar events.

Preferably the apparatus is further adapted to assign an auction category to at least some of the auction items.

According to an aspect of the invention there is provided a method of online auction of a plurality of auction items, the method comprising an auction interface presenting, on a display, a representation of a set of two or more auction items within a group auction panel; the auction interface presenting, on the display, representations of at least one member of the set of auction items within an individual auction panel; and the auction interface receiving bids from respective consumers on the set of auction items and/or individual auction items within the set of auction items.

Preferably the method further comprises determining a minimum bid for the set of auction items at least partly from the aggregate of leading bids on the individual auction items within the set of auction items.

Preferably the minimum bid for the set of auction items exceeds the aggregate of leading bids on the individual auction items within the set of auction items by a predetermined amount.

Preferably the method further comprises the auction interface presenting on the display a comparison between the leading bid on the set of auction items and the aggregate of leading bids on the individual auction items within the set of auction items.

Preferably the method further comprises the auction interface receiving a maximum bid from at least one of the consumers on the set of auction items.

Preferably the method further comprises the auction interface presenting the group auction panel above the individual auction panel on the display.

Preferably the method further comprises determining a duration for the online auction as the lesser of a predetermined maximum duration and the expiry of a predetermined break period during which there are no bids placed.

According to an aspect of the invention there is provided a method of receiving auction data from at least one contributor for an online auction, the method comprising a contributor interface receiving two or more auction items from the at least one contributor, the auction items relating to a single event or similar events assigning at least two of the auction items to a set of auction items; and an auction interface receiving bids from respective consumers on the set of auction items and/or individual auction items within the set of auction items.

Preferably the method further comprises receiving at least one auction item from two or more contributors relating to a single event or similar events.

Preferably the method further comprises assigning an auction category to at least some of the auction items.

According to an aspect of the invention there is provided an auction interface embodied on a computer-readable medium for execution on a computer programmed to enable an online auction, the auction interface adapted to present a representation of a set of two or more auction items within a group auction panel; present representations of at least one member of the set of auction items within an individual auction panel; and receive bids from respective consumers on the set of auction items and/or individual auction items within the set of auction items.

According to an aspect of the invention there is provided a contributor interface embodied on a computer-readable medium for execution on a computer programmed to enable receiving auction data from at least one contributor for an online auction, the contributor interface adapted to receive two or more auction items from the at least one contributor, the auction items relating to a single event or similar events assigning at least two of the auction items to a set of auction items; and receive bids from respective consumers on the set of auction items and/or individual auction items within the set of auction items.

According to an aspect of the invention there is provided a computer-readable medium having stored thereon computer-executable instructions that, when executed on a processing device, cause the processing device to perform a method of online auction of a plurality of auction items, the method comprising an auction interface presenting, on a display, a representation of a set of two or more auction items within a group auction panel; the auction interface presenting, on the display, representations of at least one member of the set of auction items within an individual auction panel; and the auction interface receiving bids from respective consumers on the set of auction items and/or individual auction items within the set of auction items.

According to an aspect of the invention there is provided a computer-readable medium having stored thereon computer-executable instructions that, when executed on a processing device, cause the processing device to perform a method of receiving auction data from at least one contributor for an online auction, the method comprising a contributor interface receiving two or more auction items from the at least one contributor, the auction items relating to a single event or similar events assigning at least two of the auction items to a set of auction items; and an auction interface receiving bids from respective consumers on the set of auction items and/or individual auction items within the set of auction items.

### BRIEF DESCRIPTION OF THE DRAWINGS

A preferred embodiment of the invention will now be described, by way of example only, with reference to the accompanying drawings in which:

FIG. 1 is a schematic view of an embodiment apparatus according to the invention;

FIG. 2 is a flowchart for an embodiment method according to the invention;

FIG. 3 is a schematic view representing an auction interface according to the invention;

FIG. 4 is a schematic view representing an auction interface according to the invention;

FIG. 5 is a flowchart for an embodiment method of simultaneously auctioning a a plurality of discrete content items as both a collection and each discrete item; and

FIG. 6 is a flowchart for an embodiment method of simultaneously auctioning a collection of discrete content items that are being offered for sale.

### DETAILED DESCRIPTION

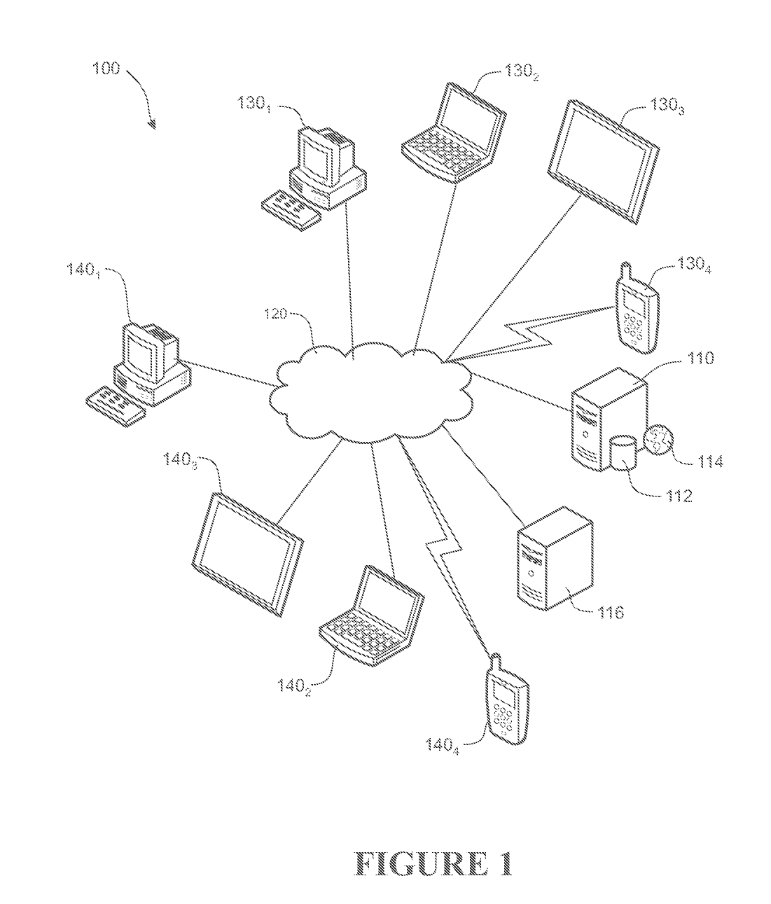

FIG. 1 shows an apparatus 100 for enabling an online auction. The apparatus 100 includes a processor element 110 coupleable to a database module 112, the database module being adapted to retain auction data.

The processor element is coupleable to a server module 114 that is adapted to present a contributor interface to contributors 1301 . . . 4 on contributor devices for receiving auction data over a data network 120 from a contributor (or supplier) 130 and to initiate an online auction.

In this embodiment, the contributor can transmit auction data in the form of a plurality of discrete items. The plurality of discrete items can be in the form of a plurality of discrete items sets. The contributor can request that the plurality of discrete items (or plurality of discrete item sets) be simultaneously auctioned as a single collection. To maintain security and/or accuracy in the auction data presented, the contributor can be registered.

Server 114 is further adapted to present an auction interface for presenting auction data over a data network 120 to one or more consumers on consumer devices 140_{1 . . . 4} and for receiving bids for an online auction.

Auction apparatus 100 optionally further includes a processor (or computing) device 116 for providing an auction item processing module for any one or more of the following:
pre-auction content editing;
pre-auction content thumbnail generation;
pre-auction content watermarking;
pre-auction content tagging;
post-auction content tagging;
post-auction content editing.

The apparatus is preferably used in providing a method of integrated online auction format that incorporates simultaneous auction for each plurality of discrete items (or plurality of discrete item sets) and all the discrete items collectively as a single collection, which will be described hereinafter with reference to this application.

By way of example only, the apparatus can be used to receive auction data in the form of a plurality of images relating to a single celebrity or event taken by a registered content provider (or contributor), and the apparatus can enable simultaneous auction for each discrete piece of content singly and collectively as a single exclusive collection. By way of a further example only, the apparatus can be used to receive auction data in the form of a plurality of content items relating to a single person or event taken by one or more registered content provider, and the apparatus can enable simultaneous auction for each discrete piece of content singly and collectively as a single exclusive collection—typically requiring either prior agreement or consent during submission from each of the one or more registered content providers. However, it will be appreciated that the invention is not limited to this particular field of use.

In use, by way of example only, a consumer can place a bid on either or both auction for each of a plurality of discrete items (or plurality of discrete item sets) and all the discrete items collectively as a single collection. The auction can be time limited (statically or dynamically).

It will be appreciated that the user interfaces are typically presented through a data communication network. For example, an interface is presented through a web interface that is viewable on a: laptop, netbook, personal computer, tablet device, mobile phone, a cell phone, smart phone, personal digital assistant or other electronic interface devices. A software application can be provided for facilitating presentation of the respective interface. In an example embodiment, an interface can be tailored for mobile or handheld devices, for example using style sheets. Alternatively, an interface can be a custom interface presented by the respective interface element.

In this embodiment, the processor element can use a web server 114 to present the contributor interface and/or auction interface via a web interface. A member (contributor or consumer) typically accesses the respective interface in the form of a web interface presented by a server (or web server) 114.

It will also be appreciated that software applications can be provided for presenting (or displaying) an interface, whereby the applications can make requests to the processor element 110 via an interface module 114 or alternatively directly access the database 114. A member can be authenticated prior to accessing a respective interface.

In an embodiment a message (or notification) is sent to interested consumers 140 in regard to any one or more of the following events:
a new auction/sale has commenced or is about to commence; and/or
the consumer has been outbid; and/or
there only remains a specified time for completion of the auction; and/or
a new consumer has displayed interest in the auction; and/or
the consumer has won the auction/sale.

It will be appreciated that FIG. 1 teaches a client-server environment distributed across a data network, such as the World Wide Web (the Web), in which an online portion of an integrated auction may take place. The architecture of the data network follows a conventional client-server model. The terms “client” and “server” are used to refer to a computer's general role as a requester of data (the client) or provider of data (the server). By way of an example only, web clients associated with devices 140 and Web servers 110 (and web server module 114) communicate using a protocol such as HyperText Transfer Protocol (HTTP). In the Web environment, Web browsers can reside on clients and render Web documents (pages) served by the Web servers. The client-server model is used to communicate information between clients and servers. Web servers are coupled to the data network (for example the Internet) and respond to document requests and/or other queries from Web clients. When a user selects a document by submitting its Uniform Resource Locator (URL), a Web browser opens a connection to a server and initiates a request (e.g., an HTTP get) for the document. The server delivers the requested document, typically in the form of a text document coded in a standard mark-up language such as HyperText Markup Language (HTML).

In an embodiment, steps of the present invention can be embodied in machine-executable instructions. The instructions can be used to cause a general-purpose or special-purpose processor which is programmed with the instructions to perform the steps of the present invention. Alternatively, the steps of the present invention might be performed by specific hardware components that contain hardwired logic for performing the steps, or by any combination of programmed computer components and custom hardware components.

The present invention may be provided as a computer program product which may include a machine-readable medium having stored thereon instructions which may be used to program a computer (or other electronic devices) to perform a process according to the present invention. The machine-readable medium may include, but is not limited to, floppy diskettes, optical disks, CD-ROMs, and magneto-optical disks, ROMs, RAMs, EPROMs, EEPROMs, magnet or optical cards, flash memory, or other type of media/machine-readable medium suitable for storing electronic instructions. Moreover, the present invention may also be downloaded as a computer program product, wherein the program may be transferred from a remote computer (e.g., a server) to a requesting computer (e.g., a client) by way of data signals embodied in a carrier wave or other propagation medium via a communication link (e.g., a modem or network connection).

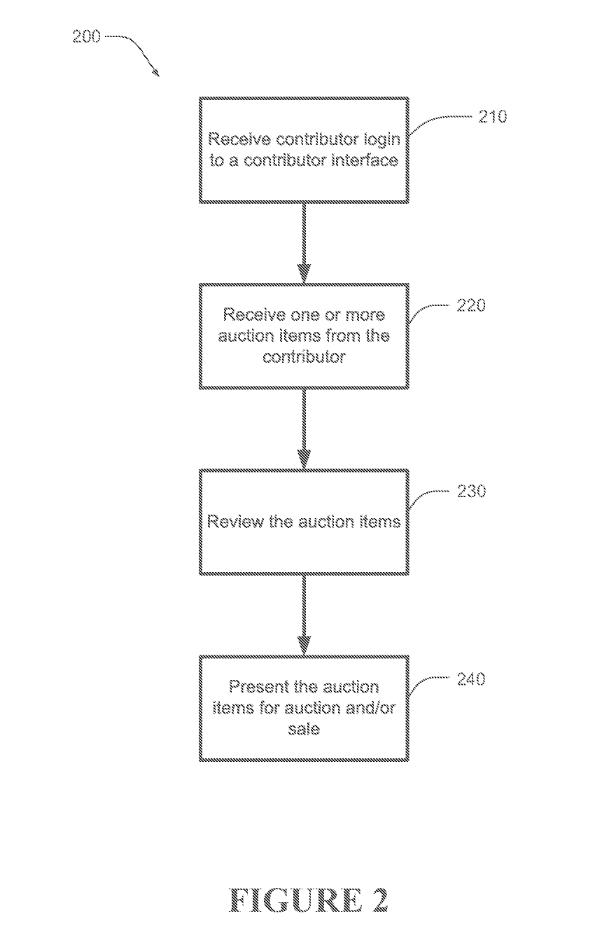

FIG. 2 shows a method 200 of receiving content for an online auctioning from a contributor 130. The method includes the steps of:
STEP: 210 receive the contributor login to the contributor interface;
STEP: 220 receive one or more auction items from the contributor;
STEP: 230 review the auction items;
STEP: 240 present the auction items for auction and sale.

It will be appreciated that a contributor can be required to agree to terms and conditions of the auction or sale that are relevant to the contributor or content items provided by the contributor—typically at registration and/or logon. The contributor can be further required to reaffirm the agreement to terms and conditions of the auction or sale at each login.

It will be appreciated that, upon receiving one or more auction items from the contributor, the contributor can be required to confirm or correct details provided about the auction items. Similarly, upon receiving one or more auction items from the contributor, the contributor can be required to provide details about the auction items.

It will be appreciated that, by way of example, STEP 210 can comprise any one or more or the following:
The contributor creates one or more auction media items in the form of a photographic data and/or video footage data and/or written content data.
The contributor obtains one or more auction media items in the form of a photographic data and/or video footage data and/or written content data.
The contributor edits the one or more auction media items, for example formatting cropping, adding metadata, and/or adding captions.
The contributor acknowledges and accepts the relevant terms and conditions for supplying auction content items. The terms and conditions can include standard industry terms as well as local auction site specific terms. These terms and conditions can be in the form of a default box that can be agreed prior to each upload.

It will be appreciated that, by way of example, STEP 220 can comprise any one or more of the following:
The contributor uploads the auction items through a web/html interface.
The contributor uploads the auction items through an ftp (file transfer protocol) interface.
The contributor emails the auction items to a predetermined email address.
The contributor submits the auction items via an app on a smartphone or tablet.
The contributor uploads the auction items through an SMS text message.
The contributor submits the auction items by other suitable electronic means.

It will be appreciated that, by way of example, STEP 230 can comprise any one or more or the following:
Promptly inspect, scrutinise and/or authenticate auction items, ensure they comply with relevant standards (for example, within 30 mins) and approve auction items for auction or “go-live”.
Act as a ‘gate-keeper’ or intermediary between the contributors (for example photographers) and consumers (for example publications/advertising agencies).
Reviewing received or uploaded auction items (for example, photographs and/or video footage).
Categorising received or uploaded auction items (for example, photographs and/or video footage) as exclusive, premium or non-exclusive.
Determine how the received or uploaded auction items (for example, photographs and/or video footage) is to be auctioned to the market (for example, exclusive auction, premium sale etc).
For auction items that are deemed to comply with the relevant terms and conditions, the compliant auction items are presented for auction to consumers and the contributor can be notified (for example, by an automatic email indicating that the content has been approved and is ready for auction). Notification can include a brief summary of the items to be auctioned. The contributor can also be presented with the option for changing standard default settings. For example, the contributor can: specify that the auction items are only to be offered to registered consumers in or for publication in certain countries; or exercise a vendor bid.
For auction items that are deemed not to comply with the relevant terms and conditions, the contributor will be notified (for example, by an automatic email indicating that the content has not been approved for auction). The notification can typically indicate why the content was not accepted, and what may be required for the content to comply with the relevant terms and conditions.

In an embodiment, by way of example only, should a contributor infringe relevant agreed terms and conditions (for example such as uploading pornography or offensive material etc), the contributor will only be given predetermined number of warnings (typically up to two (2) warnings). On a subsequent offence the contributor's registration/membership can be automatically suspended, typically pending a review.

It will be further appreciated that a plurality of non-exclusive auction item content sets (for example, from one or more providers) can be combined into one exclusive auction for a single collection. A set of auction items can be changed from non-exclusive to exclusive, should other information come to light, wherein an intimate working knowledge of the relevant local media market is typically required.

It will be appreciated that, by way of example, STEP 240 can comprise any one or more of the following:
Determining how auction items are to be presented to the market for auction and sale.
Categorising the auction items as belonging to:
   (i) Exclusive Content
   (ii) Premium price—first-rights content
   (iii) Non-Exclusive—first-rights content
   (iv) Red Carpet & Special events
   (v) Stock content.
Presenting the auction items for auction and sale through an auction/sale interface.

It will be appreciated that a role of the auction system is to ensure a smooth auction and sale process. This can be enhanced in a variety of ways, such as for example:
providing simultaneous auctions for each of a plurality of individual items and the collection of individual items;
providing simultaneous non-exclusive offers for sale for each of a plurality of individual items and auctioning the collection of individual items.

In some circumstances a contributor will be operating in a hazardous environment and/or an environment in which data networks are unreliable or prohibitively expensive. In many circumstances it would not be practical or even possible for a contributor to separately list each auction item. It is preferable for a contributor to be able to transfer a set of auction items quickly.

To meet this need the auction items are preferably uploaded by the contributor in a single batch. The auction items are then organised at a remote server into one or more sets and are passed to an auction system for simultaneous auction of each of the individual items as well is the collection of individual items.

### Exclusive Content

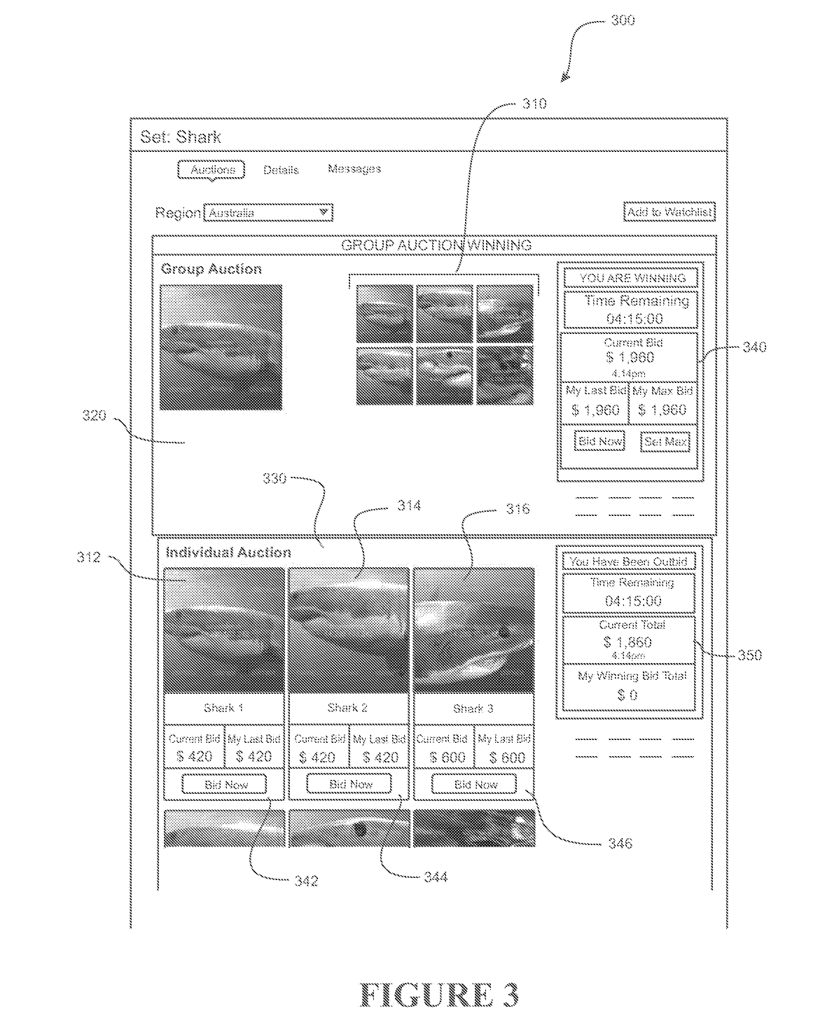

In an embodiment, exclusive content can be presented for auction and sale through an auction interface. FIG. 3, shows an exclusive content auction interface (or method) 300. It will be appreciated that, in effect, there will be a simultaneous auction for the collection or set of auction items (for example images) 310 as well as auctions for each of the distinct auction items (or distinct auction item sets) 312, 314, 316. In this example, the license of exclusive first-rights to one-use of the content for a set period of time is being auctioned. The time period will vary for different auctions and sales, but will generally be the earlier of 1 month or until 1 cycle after the content is published/broadcast/used.

By way of example, a photographer has a plurality of exclusive photos of a celebrity, event or object and provides the images for auction. All images are auctioned as Collection 310, and as three separate images 312, 314, 316.

The auction interface 300 displays for the benefit of a consumer a group auction panel 320 and an individual auction panel 330. As shown in FIG. 3 the group auction panel 320 is preferably displayed above the individual auction panel 330.

It will be appreciated that the orientation of the group auction panel 320 and the individual auction panel 330 is subject to variation. However it is generally preferred that the group auction panel 320 and the individual auction panel 330 are visible to the consumer at the same time.

The term “panel” refers to a visually demarcated area on a display of a computing device for example a laptop, netbook, personal computer, tablet device, mobile phone, cellphone, smart phone, personal digital assistant or other electronic interface device. The panel for example includes a region, window or tab.

The auction interface 300 determines a minimum bid for the set of auction items for 310. The minimum bid for the collection 310 is preferably the aggregate of currently winning/highest bids for each of the individual image auctions shown in individual auction panel 330. The minimum bid for the set of auction items 310 is determined at least partly from the aggregate of leading bids on the individual auction items shown in panel 330.

In an embodiment the minimum bid for the collection needs to exceed the aggregate of currently winning/highest bids for each of the individual image auctions by a predetermined amount. One example of a predetermined amount is an exclusive supplementary payment or premium loading.

For example, if the current bids for each of the individual image auctions are $400, $600 and $200 respectively, and an exclusive supplementary payment is set as $200, the minimum bid for the auction of the collection 310 would be $1400.

It will be appreciated that a consumer has the opportunity to place bids for exclusive one-time use of the collection of auction items and/or to place bids for exclusive one-time use of one or more of the individual images. Typically, once a bid is placed, it is accepted and cannot be withdrawn. A consumer will be responsible for full payment should they win the auction.

The auction interface 300 permits a consumer to place bids on the set of auction items 310 and/or individual auction items 312, 314 or 316. The consumer is provided with a user interface on the computing device operated by the consumer. The consumer is able to place bids with a user interface device using for example manual keypresses, user touch with finger(s) or stylus, spoken commands, gestures, or movement/orientation of the device.

As shown in FIG. 3 the auction interface 300 includes a group bid panel 340 and individual bid panels 342, 344 and 346. Group bid panel 340 is preferably displayed within group auction panel 320. Individual bid panels 342, 344 and 346 are preferably displayed within individual auction panel 330. The individual bid panels are preferably aligned or at least in close proximity to the auction images to which each of the bid panels relates.

Also shown in FIG. 3 is an aggregate panel 350. The auction interface 300 preferably displays the aggregate of leading bids on the individual auction items 312, 314 and 316. There is preferably displayed to the consumer a comparison between the leading bid on the set of auction items and the aggregate of leading bids on the individual auction items.

Group bid panel 340 and aggregate panel 350 preferably include a status indicator. In FIG. 3 it can be seen that the leading bid on set 310 exceeds the aggregate of individual items 312, 314 and 316. The message “you are winning” is displayed in group bid panel for 340. The message “you have been outbid” is displayed within aggregate panel 350. Preferably the two messages are presented in a visually distinct manner to aid the consumer in interpreting the comparison.

Auction interface 300 is presently configured to receive a maximum bid from at least one of the consumers on the set of auction items. This is the current maximum bid and options for resetting the maximum bid are shown within group bid panel 340.

The winner of the auction can be determined as being either: the highest bidder on the collection if the final bid is greater than the sum of final bids placed on the individual items (plus any supplementary payment requirement); or each of the highest bidders on each of the individual auction items if the sum of final bids placed on the individual items (plus any supplementary payment requirement) is greater than the final bid placed on the collection auction item.

In an embodiment, for example—when bidding on exclusive images—if a consumer is bidding on individual images (also offered in a collection) and intends using the images across a plurality of publications or titles, the consumer must nominate the number of publications/titles. According to respective consumer user agreements, a consumer may receive a discount for two or more publications, typically a predetermined set discount that is fixed pre-auction.

In an embodiment, for example—when bidding on an exclusive collection of images—a further loading premium (for example 10-25%) can be applied to the winning bid for each additional title. By way of example only, if a consumer is the highest bidder on an auction content item, and they wish to use that image across multiple publications/titles, then the actual price payable can be calculated to further include a 25% loading for a second title and a 15% loading for a third title and a 10% loading for subsequent titles.

In an embodiment, for example, a further loading may also be applied to the winning bid price for a cover-picture or cover-insert—being use of the auction item on the front cover. This can be invoiced at initial sale or post use.

If an exclusive auction concludes without bids being placed (excluding any Vendor bid), the auction items image or collection of auction items can be automatically relegated to a premium first rights category, and then subsequently to a stock library category. Before items or images are moved to the stock library, they will typically be edited/tagged/keyworded to ensure ease of search for future consumers/purchasers.

Auctions can be conducted daily in the various markets throughout the world. For example, auctions can start at 7 am in the local jurisdiction and will be conducted throughout the day as content is uploaded to the site from around the world. Excepting any exclusions, content received after a predetermined time limit will be held over until the following day in that jurisdiction, wherein an auction can recommence.

The auctions will last until the earlier of a predetermined maximum duration (for example six hours), or the expiry of a predetermined break period during which there are no further bids placed. An example break period comprises one hour. Once there has been no bidding for a first period (for example thirty minutes) all parties involved with the auction can be notified by email that the auction will be closing in 30 mins and provide an indication of the current highest bid.

An auction term may be extended. At which time, the additional auction period can be advertised to involved parties to the auction.

Consumers can have the ability to place a maximum bid at the start of the auction process (or at any time during the auction term). This enables the consumer to not have to continually monitor the auction process. At any time, a consumer may alter or increase a maximum bid. The auction system can continue to bid on behalf of the consumer, against one or more other bidders/consumers that are participating in the auction, up to the maximum bid price.

If a consumer places a respective maximum bid on both individual auction items and the collection of auction items, the auction system will not apply the bids against each other. However, the system can be configured (for example pre-configured or consumer defined) to favour either one or more individual auction items or the collection of items when bidding, deferring to the other option when bids for the first preference are exhausted.

### Premium Price—First Rights Content

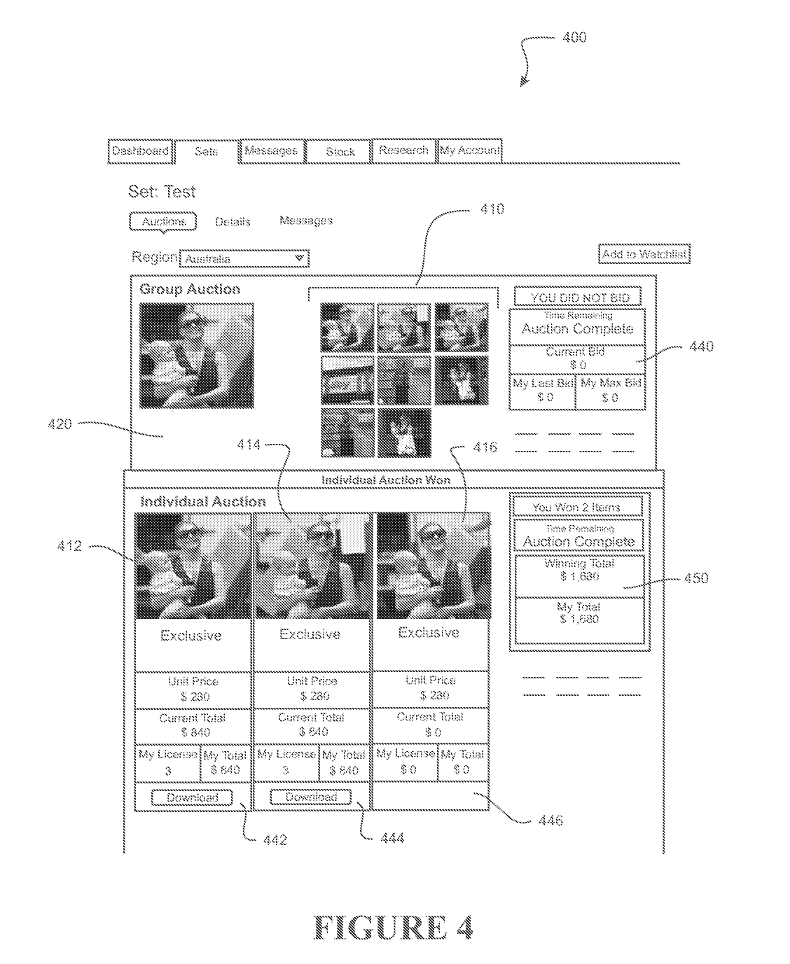

In an embodiment, premium price—first rights content—can be presented for auction and sale through an auction/sale interface. FIG. 4 shows a premium price auction interface 400.

It will be appreciated that, simultaneously, an auction is held for an exclusive one-time license for the entire collection or set of items 410, while consumers may purchase rights to use an individual item 412, 414 and 416 at a predetermined premium-price.

The auction interface 400 displays for the benefit of a consumer a group auction panel 420 and an individual auction panel 430. As shown in FIG. 4 the group auction panel 420 is preferably displayed above the individual auction panel 430.

It will be appreciated that the orientation of the group auction panel 420 and the individual auction panel 430 is subject to variation. However it is generally preferred that the group auction panel 420 and the individual auction panel 430 are visible to the consumer at the same time.

Auction interface 400 includes a group bid panel 440. In this example the auction has closed and there were no bids for the set of auction items 410.

There is also displayed to the consumer individual bid/purchase panels 442, 444 and 446. Also displayed is an aggregate panel 450. The aggregate panel 450 displays the aggregate of bids or purchases made by consumers within individual bid panels 442, 444 and 446. Individual bid panels 442, 444 and 446 permit a consumer to enter a bid in the form of a predetermined premium-price.

The predetermined premium-price can be the same or different for each item. A consumer can enter the required per-title/per-publication use and may receive a discount according to a previously-set agreement.

The auction of the content is typically for the right to use the respective item for a predetermined-period of time, but will generally be the earlier of 1 month or until 1 cycle after the content is published/broadcast/used.

It will be appreciated that the corresponding per-use/per-title fee offered can increase the auction minimum bid price accordingly. If a consumer uses any item beyond the final agreed quantity, a single end-user fee can be further applied.

By way of example only, the auction collection 410 comprises the set of images 412, 414 and 416. The minimum winning bid for the collection must be greater than the aggregate of individual image(s) therefore the next bid placed on the collection must exceed this amount. The auction interface 400 can dynamically update the minimum next bid.

By way of example only, the auction images 412, 414 and 416 each have a predetermined single image/single use/single title purchase price. The orders placed on each image are non-exclusive. The total revenue calculated for an image is the sum of all current orders.

The winners of the premium price—first rights content—auction/purchase will be determined at the conclusion of the auction period.

In this example embodiment the predetermined single image/single use/single title purchase price for each image is set to $280. A first consumer places a premium purchase order for image 412 for use across 4 titles—being a fee of $840. A second consumer places a premium purchase order for image 414 for use across 3 titles—being a fee of $840.

In order to determine the winner of the premium auction/purchase, the highest auction bid for the collection 410 is compared against the aggregate total revenue calculated for all current orders placed on the images 412, 414, 416. If the highest auction bid for the collection 410 is greater than the aggregate total revenue calculated for all current orders placed on the images 412, 414, 416 including any premium exclusive levy, then the holder of the highest auction bid has exclusive rights to the images subject to the terms of use.

If the highest auction bid for the collection 410 is greater than the aggregate total revenue calculated for all current orders placed on the images 412, 414, 416 including any premium exclusive levy, then consumers holding current premium purchase order rights to the images 412, 414, 416 have non-exclusive right to use the respective images subject to the terms of use.

In this example there were no bids on the set of auction items 410.

The consumer, when placing a premium purchase order, is buying the non-exclusive rights to a specific image. If the consumer wishes to use the image across several publications, then they need to enter the quantity required. Once a bid/offer is placed, it is automatically accepted, and the consumer will be responsible for payment should they win the premium auction/purchase.

If an auction concludes with no bids/offers being placed on the image or collection of images, the image or collection of images can be automatically moved to a stock library. Before images are moved to a stock library they can be tagged to ensure ease of search for future purchasers.

The premium auction/purchase will typically last until the earlier of a predetermined maximum duration (for example six hours), or until there has been no further bids placed for a predetermined break period (for example one hour). Once there has been no bidding for a first period (for example thirty minutes) all parties involved with the auction can be notified by email that the auction will be closing in 30 mins and provide an indication of the current highest bid/purchase.

Bids are typically required to exceed the previous winning bid, aggregate purchase revenue, by a minimum amount (for example $100 above the previous winning bid or aggregate purchase revenue). A consumer can have the ability to specify a maximum bid amount, allowing the auction apparatus to automatically place proxy bids up to the maximum amount on behalf of the respective consumer.

### Standard Non-Exclusive Content/Red Carpet

Standard non-exclusive content items (for example, relating to red carpet and special event images or media) can also be directly offered for sale, wherein prospective buyers can submit an offer to purchase non-exclusive rights to use that content, in which the buyer enters the publications/formats in which the buyer intends to publish the content—and the fee is calculated accordingly.

These non-exclusive stock content items can be offered for a predetermined period. It will be appreciated that these content items can be offered in a content interface, similar to the portion of the auction interface 400 (as shown in FIG. 4) but excluding the auctioning of the collection 410. Accordingly, non-exclusive stock content items can be sold according to at least one stock library pricing schedule. The pricing schedule can be based on a set-fee per-use fee, depending on the intended/claimed use (for example publications/formats) of the content being purchased.

### Stock Library

It will be appreciated that non-exclusive stock content (for example, relating to red carpet and special events) can be sold according to at least one stock library pricing schedule—on a set-fee per-use basis depending on the use of the image/s being purchased.

### Online Simultaneous Auctions

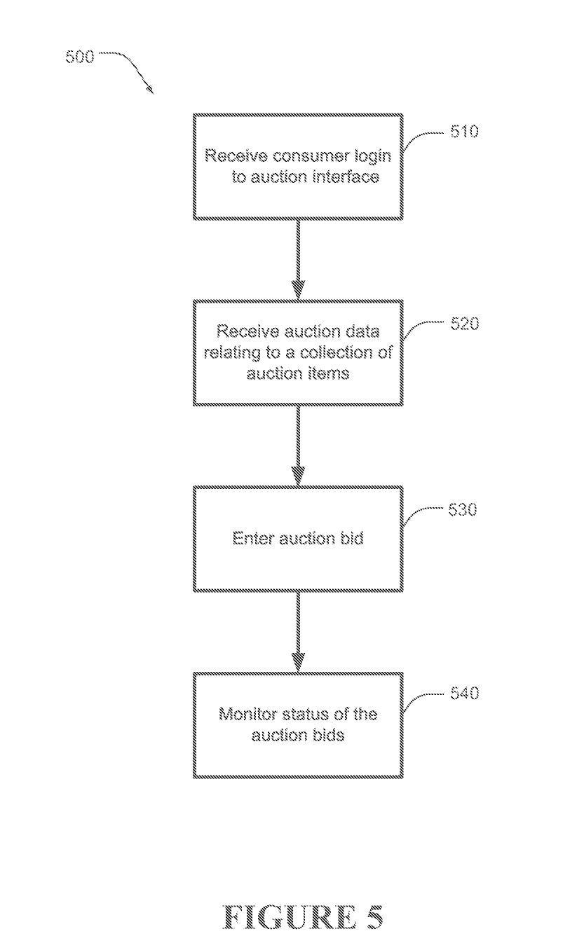

FIG. 5 shows a method 500 of a consumer engaging in an online auction of a plurality of auction items. In this example, the plurality of discrete auction items are being simultaneously auctioned as a single collection and separate discrete content items. The method 500 is typically associated with exclusive content. The method includes the steps of:
STEP: 510 receiving the consumer login to the auction interface;
STEP: 520 receiving auction data relating to a collection of auction items comprising a plurality of discrete auction items;
STEP: 530 entering a bid (or offer) on the collection of auction items and/or one or more of the plurality of discrete auction items; and
STEP: 540 (optionally) monitoring the status of the auction bids.

### Online Simultaneous Auction and Sale

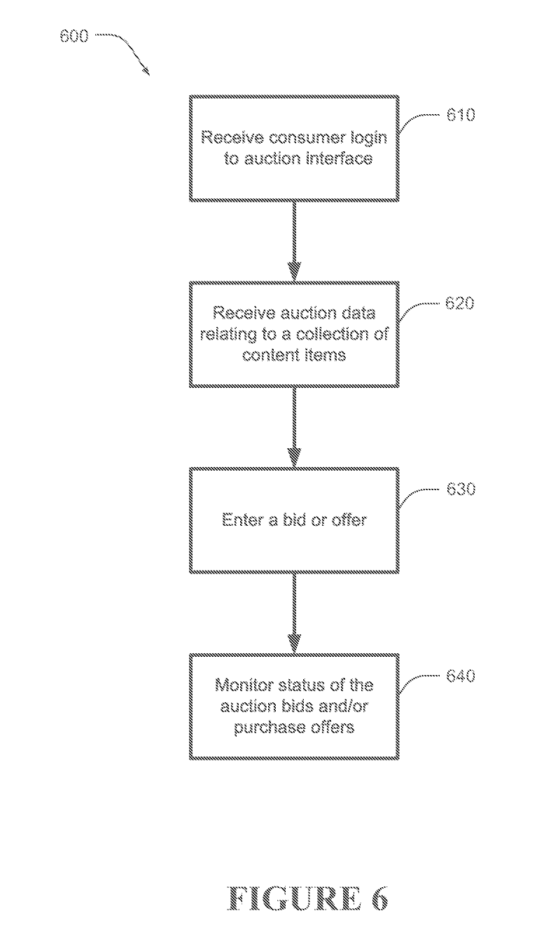

FIG. 6 shows a method 600 of a consumer engaging in an online auction of a plurality of content items, wherein each of the content items are also being simultaneously offered for sale. The method 600 is typically associated with premium price/first rights Content. The method includes the steps of:
STEP: 610 receiving the consumer login to the auction interface;
STEP: 620 receiving auction data relating to a collection of content items offered for auction, the collection of content items comprising a plurality of discrete content items being offered for sale;
STEP: 630 entering a bid on the collection of content items and/or a purchase offer for one or more of the plurality of discrete content items; and
STEP: 640 (optionally) monitoring the status of the auction bids and purchase offers.

### Content Delivery

Once an auction has concluded, the winning bidder/consumer/purchaser can be notified and sent a hyper-link from which they can download the respective high resolution digital content (for example, images and video).

The winning bidder/consumer/purchaser can be prompted to indicate or confirm the business line in which they intend to use the content. Alternatively, the business line in which a consumer intends to use the content may have been indicated or confirmed when placing an auction bid or purchase offer.

The winning bidder/consumer/purchaser can be prompted to indicate or confirm if additional rights (for example, web, tablet, app, etc) are to be purchased at an additional cost. Alternatively, a consumer may indicate or confirm an intention or authority to purchase additional rights when placing an auction bid or purchase offer, which is to be applied upon submitting a winning auction bid or purchase offer.

It will be appreciated that the digital content may be tagged or watermarked to:
enable digital rights management on the digital content; and/or
identify the origin of the digital content; and/or
embed terms of use for the digital content;

The content can be accompanied by an automatically generated invoice with standard payment terms as per original registration terms and conditions. Accounts may also be automatically suspended/disabled if payment is not made in accordance with the terms and conditions.

### Content Terms

Content contributor/provider terms can incorporate a plurality of different payment plans. For example:
By electing to be paid upon receipt of payment from a consumer, an exchange fee (for example 25%) may be deducted for the auction services,
By electing to be paid weekly, an exchange fee (for example 25%) may be withheld for the auction services, wherein contributors are paid on all invoices older than a week. A risk loading (for example 15%) will also be applied to compensate for additional risks and costs associated with this facility.

Typically all contributors, although not mandatory, are professional members of a local association (for example, Journalist association, photo-journalist union or professional body).

In an embodiment, by way of example only, all contributors/providers agree to one or more of the following further terms and conditions:
The contributor warrants that either he/she is the actual creator of the material and that the material submitted is not copied, or downloaded from another creator, person or website. In the circumstances of the written word, including photographic captions, that no sentences are cut and pasted from another creator, including websites.
That all spelling of names and geographical locations are correct.
That notes forming part of the captions are written, so that no claims of defamation or libel can exist. i.e. Mystery woman should be un-identified female. No suggestive term or adjectives should be used.
The date, time and place of the images/video or content created is noted correctly.
In the circumstances of images and video, that all material is obtained legally and without aggravation. That no local/federal laws have been broken. i.e. No trespass or any reasonable rights to privacy have been breached.
That all material created will be exclusively offered for 3 months and following which, if not withdrawn, will remain for a further 1 year during which time the material (content) will be value added. i.e. Keyworded, promoted. Etc.
That material marked either exclusive or premium non-exclusive is carefully considered by the photographer/creator.
That material is not offensive, lewd or immoral.
In the event of written content, all sources are quoted, must be available for fact checks and these contacts will be provided for all submissions. Non-attributable quotes will be possible, only with details of sources.

In an embodiment, by way of example only, all contributors/providers who are agents may be required to further agree to one or more of the following further terms and conditions:
The agency will receive 75% of the total sale(s) price. Agencies (as opposed to single contributors) will be paid upon receipt of a consumer payment.
The auction provider will not interfere with or become involved in any disputes between photographers and agents.
Agencies warrant they will on-pass all commissions due to any creator or photographer, for whom they either jointly or separately submit material according to normal terms and conditions.
If the copyright holder is not the agent, the agent will credit the photographer or content provider for the image in a joint credit.

In an embodiment, by way of example only, all consumers/purchasers may be required to agree to one or more of the following further terms and conditions:
Print Rights—Newspapers and magazines
   Material cannot be used for advertising purposes except in an editorial capacity. (i.e. Promoting the publication is fine, promoting a product or non-editorial endorsement is not.)
   A cover or cover-insert will attract a standard fee—with spot-use adding 100% to the individual price of a premium single-fee image or in the case of an exclusive image used-full cover, a loading fee (for example 10%) of the total purchase price per-set will prevail. These additional fees will be noted in clear terms in an end-user agreement.
   One-time, one-use without options for on-passing the content.
   Will be for the use of 1 print cycle from publication or 1 month.
   Web use without end-user agreement involves a fee (for example 10%).
   All web use is re-invoiced yearly for any image remaining on your web-site.
   All auctions are only for local, state or federal (national) publications. World-rights are not offered unless it is a world-rights auction. Jurisdiction can be specified in the auction terms.
   Bidding with magazines and newspapers for print-rights does not assume TV or online broadcast rights. For these rights, the winning bidders must convert these rights for a nominal fee.
   All video or moving pictures images are offered separately. In some circumstances these will be offered to highest bidder of any print-rights auction, if applicable or a separate auction will be held.
Broadcast Rights—TV, Online and Web
   Non-exclusive stand-alone news footage will be offered to end-users on the auction system using the premium-fee platform.
   All non-exclusive TV broadcast footage will be offered at standard rates per clip/story (unless bid above-the-line) and will be available at a premium fee to be fixed. This fee normally be, for example $800.
   Exclusive TV broadcast footage will be offered in above the-line auctions scheduled to be held as footage is received. If this material is time sensitive and strategic to competitors, an alert will be sent.
   Second-rights footage use is offered to newspapers and magazines for a stock price.
   Footage sales are for one broadcast cycle. Re-use will incur an additional fee.
Written content—Stories, Celebrity briefs and picture captions
   All captions are licensed to the auction provider on behalf of the writer.
   All material is original.
   Stories, features or news brief will have source contacts for fact checking and where necessary, the contact details of all the interviewed subjects.
   PR material will be removed.
   If material provided from taped or recorded interviews, these may be offered as audio.

It will be appreciated that the illustrated embodiments teach an auction apparatus and method.

It will be appreciated that, some of the embodiments are described herein as a method or combination of elements of a method that can be implemented by a processor of a computer system or by other means of carrying out the function. Thus, a processor with the necessary instructions for carrying out such a method or element of a method forms a means for carrying out the method or element of a method. Furthermore, an element described herein of an apparatus embodiment is an example of a means for carrying out the function performed by the element for the purpose of carrying out the invention.

In alternative embodiments, the one or more processors operate as a standalone device or may be connected, e.g., networked to other processor(s), in a networked deployment, the one or more processors may operate in the capacity of a server or a client machine in server-client network environment, or as a peer machine in a peer-to-peer or distributed network environment.

Thus, one embodiment of each of the methods described herein is in the form of a computer-readable carrier medium carrying a set of instructions (e.g. a computer program) that are for execution on one or more processors.

Unless specifically stated otherwise, as apparent from the following discussions, it is appreciated that throughout the specification discussions utilizing terms such as “processing”, “computing”, “calculating”, “determining” or the like, can refer to the action and/or processes of a computer or computing system, or similar electronic computing device, that manipulate and/or transform data represented as physical, such as electronic, quantities into other data similarly represented as physical quantities.

In a similar manner, the term “processor” may refer to any device or portion of a device that processes electronic data, e.g., from registers and/or memory to transform that electronic data into other electronic data that, e.g., may be stored in registers and/or memory. A “computer” or a “computing machine” or a “computing platform” may include one or more processors.

The methodologies described herein are, in one embodiment, performable by one or more processors that accept computer-readable (also called machine-readable) code containing a set of instructions that when executed by one or more of the processors carry out at least one of the methods described herein. Any processor capable of executing a set of instructions (sequential or otherwise) that specify actions to be taken is included.

Similarly, it is to be noted that the term “coupled”, when used in the claims, should not be interpreted as being limited to direct connections only. The terms “coupled” and “connected”, along with their derivatives, may be used. It should be understood that these terms are not intended as synonyms for each other. Thus, the scope of the expression “a device A coupled to a device B” should not be limited to devices or systems wherein an output of device A is directly connected to an input of device B. It means that there exists a path between an output of A and an input of B which may be a path including other devices or means. “Coupled” may mean that two or more elements are either in direct physical or electrical contact, or that two or more elements are not in direct contact with each other but yet still co-operate or interact with each other.

As used herein, unless otherwise specified the use of the ordinal adjectives “first”, “second”, “third”, etc., to describe a common object, merely indicate that different instances of like objects are being referred to, and are not intended to imply that the objects so described must be in a given sequence, either temporally, spatially, in ranking, or in any other manner.

Reference throughout this specification to “one embodiment” or “an embodiment” means that a particular feature, structure or characteristic described in connection with the embodiment is included in at least one embodiment. Thus, appearances of the phrases “in one embodiment” or “in an embodiment” in various places throughout this specification are not necessarily all referring to the same embodiment, but may refer to the same embodiment. Furthermore, the particular features, structures or characteristics may be combined in any suitable manner, as would be apparent to one of ordinary skill in the art from this disclosure, in one or more embodiments.

Similarly it should be appreciated that in the above description of exemplary embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those in the art. For example, in the following claims, any of the claimed embodiments can be used in any combination.

In the description provided herein, numerous specific details are set forth. However, it is understood that embodiments of the invention may be practiced without these specific details. In other instances, well-known methods, structures and techniques have not been shown in detail in order not to obscure an understanding of this description. Although the invention has been described with reference to specific examples, it will be appreciated by those skilled in the art that the invention may be embodied in many other forms.

It will be appreciated that an embodiment of the invention can consist essentially of features disclosed herein. Alternatively, an embodiment of the invention can consist of features disclosed herein. The invention illustratively disclosed herein suitably may be practiced in the absence of any element which is not specifically disclosed herein.

1. Apparatus for enabling an online auction comprising:
a processor;
a database module coupleable to the processor, the database module adapted to retain data representing auction items; and
a server coupleable to the processor, the server adapted to present an auction interface to a consumer on a display, the auction interface adapted to:
present a representation of a set of two or more auction items within a group auction panel;
present representations of at least one member of the set of auction items within an individual auction panel; and
receive bids from respective consumers on the set of auction items and/or individual auction items within the set of auction items.

2. The apparatus of claim 1 adapted to determine a minimum bid for the set of auction items at least partly from the aggregate of leading bids on the individual auction items within the set of auction items.

3. The apparatus of claim 2 wherein the minimum bid for the set of auction items exceeds the aggregate of leading bids on the individual auction items within the set of auction items by a predetermined amount.

4. The apparatus of claim 1 wherein the auction interface is further adapted to present on the display a comparison between the leading bid on the set of auction items and the aggregate of leading bids on the individual auction items within the set of auction items.

5. The apparatus of claim 1 wherein the auction interface is further adapted to receive a maximum bid from at least one of the consumers on the set of auction items.

6. The apparatus of claim 1 wherein the auction interface is further adapted to present the group auction panel above the individual auction panel on the display.

7. The apparatus of claim 1 further adapted to determine a duration for the online auction as the lesser of a predetermined maximum duration and the expiry of a predetermined break period during which there are no bids placed.

8. Apparatus for enabling receiving auction data from at least one contributor for an online auction, the apparatus comprising:
a processor;
a database module coupleable to the processor, the database module adapted to retain data representing auction items; and
a server coupleable to the processor, the server adapted to present a contributor interface to a contributor on a display, the contributor interface adapted to:
receive two or more auction items from the at least one contributor, the auction items relating to a single event or similar events assigning at least two of the auction items to a set of auction items; and
receive bids from respective consumers on the set of auction items and/or individual auction items within the set of auction items.

9. The apparatus of claim 8 wherein the contributor interface is further adapted to receive at least one auction item from two or more contributors relating to a single event or similar events.

10. The apparatus of claim 8 further adapted to assign an auction category to at least some of the auction items.

11. A method of online auction of a plurality of auction items, the method comprising:
an auction interface presenting, on a display, a representation of a set of two or more auction items within a group auction panel;
the auction interface presenting, on the display, representations of at least one member of the set of auction items within an individual auction panel; and
the auction interface receiving bids from respective consumers on the set of auction items and/or individual auction items within the set of auction items.

12. The method of claim 11 comprising determining a minimum bid for the set of auction items at least partly from the aggregate of leading bids on the individual auction items within the set of auction items.

13. The method of claim 12 wherein the minimum bid for the set of auction items exceeds the aggregate of leading bids on the individual auction items within the set of auction items by a predetermined amount.

14. The method of claim 11 further comprising the auction interface presenting on the display a comparison between the leading bid on the set of auction items and the aggregate of leading bids on the individual auction items within the set of auction items.

15. The method of claim 11 further comprising the auction interface receiving a maximum bid from at least one of the consumers on the set of auction items.

16. The method of claim 11 further comprising the auction interface presenting the group auction panel above the individual auction panel on the display.

17. The method of claim 11 further comprising determining a duration for the online auction as the lesser of a predetermined maximum duration and the expiry of a predetermined break period during which there are no bids placed.

18. A method of receiving auction data from at least one contributor for an online auction, the method comprising:
a contributor interface receiving two or more auction items from the at least one contributor, the auction items relating to a single event or similar events assigning at least two of the auction items to a set of auction items; and
an auction interface receiving bids from respective consumers on the set of auction items and/or individual auction items within the set of auction items.

19. The method of claim 18 further comprising receiving at least one auction item from two or more contributors relating to a single event or similar events.

20. The method of claim 18 or claim 19 further comprising assigning an auction category to at least some of the auction items.

21. An auction interface embodied on a computer-readable medium for execution on a computer programmed to enable an online auction, the auction interface adapted to:
present a representation of a set of two or more auction items within a group auction panel;
present representations of at least one member of the set of auction items within an individual auction panel; and
receive bids from respective consumers on the set of auction items and/or individual auction items within the set of auction items.

22. A contributor interface embodied on a computer-readable medium for execution on a computer programmed to enable receiving auction data from at least one contributor for an online auction, the contributor interface adapted to:
receive two or more auction items from the at least one contributor, the auction items relating to a single event or similar events assigning at least two of the auction items to a set of auction items; and
receive bids from respective consumers on the set of auction items and/or individual auction items within the set of auction items.

23. A computer-readable medium having stored thereon computer-executable instructions that, when executed on a processing device, cause the processing device to perform a method of online auction of a plurality of auction items, the method comprising:
an auction interface presenting, on a display, a representation of a set of two or more auction items within a group auction panel;
the auction interface presenting, on the display, representations of at least one member of the set of auction items within an individual auction panel; and
the auction interface receiving bids from respective consumers on the set of auction items and/or individual auction items within the set of auction items.

24. A computer-readable medium having stored thereon computer-executable instructions that, when executed on a processing device, cause the processing device to perform a method of receiving auction data from at least one contributor for an online auction, the method comprising:
a contributor interface receiving two or more auction items from the at least one contributor, the auction items relating to a single event or similar events assigning at least two of the auction items to a set of auction items; and
an auction interface receiving bids from respective consumers on the set of auction items and/or individual auction items within the set of auction items.
